(19) United States
(12) Patent Application Publication
(10) Pub. No.: US 2026/0160130 A1
(43) Pub. Date: Jun. 11, 2026

(54) SCREENED ENCLOSURE SYSTEM

(71) Applicant: Replace My Cage, LLC, Sarasota, FL (US)

(72) Inventor: Dustin KEITH, Sarasota, FL (US)

(73) Assignee: Replace My Cage, LLC, Sarasota, FL (US)

(21) Appl. No.: 19/412,642

(22) Filed: Dec. 8, 2025

Related U.S. Application Data
(60) Provisional application No. 63/729,103, filed on Dec. 6, 2024.

(51) Int. Cl. E06B 9/52; E04B 2/58

(52) U.S. Cl. CPC E06B 9/52; E04B 2/58

(57) ABSTRACT

A screened enclosure system comprising an improved aluminum beam profile. The beam features an internal reinforcement structure formed by opposing arcuate walls that create a central hourglass void and outer half-moon voids, providing superior resistance to wind loads. Additionally, the beam profile includes dual-directional spline grooves located at the exterior corners, allowing screening to be attached to either the vertical or horizontal faces of the beam.

### CROSS-REFERENCE TO RELATED APPLICATION

This application claims priority to and the benefit of U.S. Provisional Patent Application No. 63/729,103 (filed Dec. 6, 2024) which is incorporated by reference herein in its entirety.

### GENERAL DESCRIPTION

Various aspects of this disclosure relate generally to building systems and screened enclosures, and more particularly, to improved aluminum beam profiles, structural inserts, and screening configurations used in the construction of pool cages, lanais, and similar outdoor structures.

In regions with hot and humid climates, such as Florida and other coastal areas, homeowners frequently utilize outdoor pools for recreation and exercise. To protect these areas from intrusion by trespassers, debris, and insects (e.g., mosquitoes and flies), these pools are often enclosed by screened structures. These structures, commonly referred to as pool cages or screen enclosures, are typically constructed using aluminum beam framing and insect screening (or any other screening barrier known in the art).

A significant challenge facing the enclosure industry is the structural integrity of these cages during severe weather events. In areas prone to hurricanes and high-wind conditions, a high percentage of these structures are vulnerable to severe damage and failure. Conventional aluminum enclosure roof systems typically utilize beams comprising hollow rectangular box extrusions. As homeowners desire larger spans to create unobstructed views, the necessary beams become larger, heavier, and more expensive.

Furthermore, prior art beams typically featured a spline groove (for holding the screen) on only one face or required the attachment of a separate “1×2” aluminum strip to create a spline groove on a different face or corner. This added material cost, labor, and aesthetic clutter.

Accordingly, the inventors have recognized a need for improved screened enclosure components that offer superior strength-to-weight ratios through novel internal geometries, improved modularity through structural inserts, and improved versatility through multi-directional spline configurations.

### SUMMARY

The present disclosure describes three primary improvements over the prior art: (1) a beam profile utilizing internal arcuate arches to create an hourglass reinforcement structure; (2) a structural insert designed to fit within the beam voids as additional reinforcement; and (3) a dual-directional spline groove configuration located at the beam corners to allow screening on multiple faces without additional adapters.

In one aspect, a disclosed embodiment includes an extruded aluminum beam structure having a cross-sectional profile with a generally rectangular perimeter wall. The profile includes at least one, and preferably two, opposing arcuate internal walls. These walls curve inward toward the center of the beam, meeting or approximating each other to form a central web. This geometry creates three distinct voids: a central hourglass shaped void and two outer half-moon shaped voids. This internal arch structure resists buckling forces more effectively than standard straight-walled box beams.

In another aspect, a structural beam insert is disclosed. This insert is sized and shaped to slide into the internal voids of the beam, specifically the central hourglass void. The insert acts as a stiffener to increase the load-bearing capacity of the span.

In yet another aspect, a multi-directional screening feature is disclosed herein. The exterior corners of the beam profile includes dual spline grooves (slots). A first slot faces a first direction (e.g., substantially vertically) and a second slot faces a second direction (e.g., substantially horizontally) at the same corner. This allows the installer to attach the screen mesh to either the top/bottom or the side fascia of the beam.

These and other objects, features, and advantages of the present invention will become apparent from the following detailed description and the appended claims.

In one embodiment, an aluminum beam for a screened enclosure is disclosed. The beam comprising a perimeter wall defining a generally rectangular cross-section having two opposing major walls and two opposing minor walls, a first spline groove located substantially at a corner of the perimeter wall, the first spline groove oriented to receive a screen spline from a first direction, and a second spline groove located substantially at the same corner of the perimeter wall, the second spline groove oriented to receive a screen spline from a second direction different from the first direction.

In another embodiment, an extruded structural beam is disclosed. The beam comprising a generally rectangular outer perimeter wall, a first internal arcuate wall extending inwardly from a first side of the outer perimeter wall, and a second internal arcuate wall extending inwardly from a second opposing side of the outer perimeter wall, wherein the first and second internal arcuate walls generally oppose each other to define a central void having a substantially hourglass-shaped cross-section.

In another embodiment, a structural beam assembly is disclosed. The assembly comprising an extruded beam having an exterior rectangular wall and an interior web structure comprising two opposing curved walls that define a central hourglass-shaped channel, a structural insert dimensioned to be slidably received within the central hourglass-shaped channel, and wherein the structural insert reinforces the extruded beam.

### BRIEF DESCRIPTION OF THE DRAWINGS

The features, aspects, and advantages of the disclosed deliver system will become apparent from the following description, and the accompanying exemplary embodiments shown in the drawings, which are briefly described below.

FIG. 1 is a perspective view of a residential structure including a screened enclosure constructed using the beam systems of the present disclosure.

FIG. 2 is an interior perspective view of the screened enclosure of FIG. 1, illustrating the large unobstructed viewing area achieved by the improved beam spans.

FIG. 3 is a cross-sectional view of a half-beam extrusion profile, illustrating a single arcuate internal wall.

FIG. 4 is a cross-sectional view of a fully assembled beam profile comprising two half-beams, illustrating the opposing arcuate walls and the central hourglass void.

FIG. 5 is a cross-sectional view of the beam of FIG. 4 further comprising a structural insert disposed within the central void.

FIG. 6 is a detailed cross-sectional view of fully assembled beam highlighting the dual-directional corner spline slots.

FIG. 7 is a cross-sectional close-up view of the dual-directional corner spline slots shown in the circle portion designated “A” in FIG. 6.

FIG. 8 is a cross-sectional view of a square beam embodiment.

FIG. 9 is a partial perspective cross-sectional view showing the interface between the screen mesh, the spline groove, and a flexible spline, illustrating the retention mechanism against pull-out forces.

### DETAILED DESCRIPTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

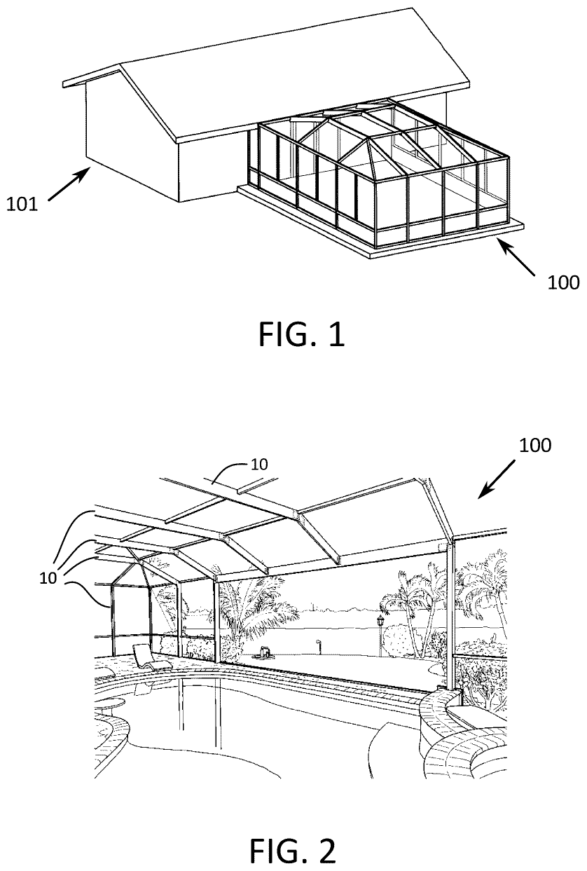

Referring to FIG. 1, a screened enclosure system 100 is depicted attached to a host structure 101 (e.g., a residential home). The enclosure includes a structural framework formed by a plurality of upright posts supporting a roof structure comprising a plurality of roof beams. Panels of screen mesh are retained within the framework to define an enclosed outdoor living space. The framework is constructed utilizing the improved aluminum beam profiles disclosed herein, which are engineered to resist high wind loads common in coastal regions while accommodating standard screening materials.

Referring to FIG. 2, an interior view of the enclosure 100 demonstrates the structural advantages of the system. The roof beams are capable of achieving extended spans across the width of the enclosed area (e.g., over a swimming pool) without requiring intermediate vertical supports that would otherwise clutter the view. This capability creates a large, unobstructed viewing area, enhancing the aesthetic value of the enclosure. The increased rigidity provided by the internal geometry of the beams, specifically features discussed below, allows for these longer spans while minimizing deflection and reducing the total weight of the superstructure.

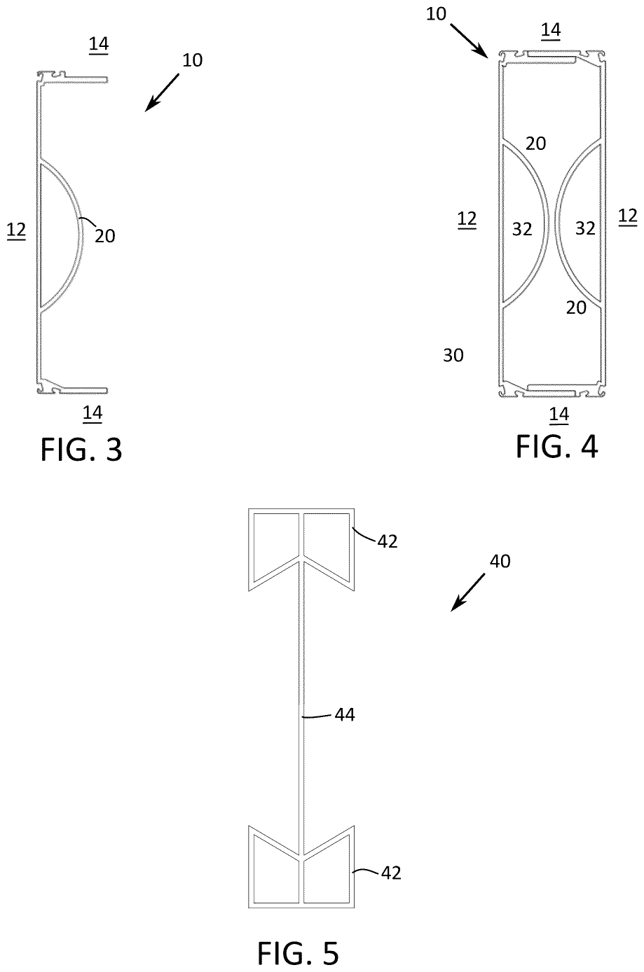

Referring to FIGS. 3 and 4, an improved beam profile 10 is disclosed. The beam may include a generally rectangular perimeter defined by opposing major walls 12 (fascia) and opposing minor walls 14 (top/bottom). Unlike hollow box beams of the prior art, the interior is reinforced by arcuate (curved) internal walls 20.

As shown in FIG. 4, when two profiles are joined (e.g., formed of two mating halves where the arcuate walls are integral to each half) or extruded as a single unit, the opposing arcuate walls 20 curve inward toward the vertical center line of the beam. This creates a specific internal geometry: a central void or channel 30 having a substantially hourglass shape (wide at top/bottom, narrow at the center) and two outer voids 32 having a substantially half-moon or “D” shape. This arch geometry transfers vertical loads from the minor walls 14 into the major walls 12 more efficiently than straight ribs, resisting buckling under hurricane-force winds. In various embodiments, the first and second internal arcuate walls 20 are continuous curves having a constant radius. The walls 20 converge toward a vertical centerline of the beam such that the central void 30 is narrowest at a middle point and widest at the minor walls. In some configurations, the arcuate walls include an arch height that is less than half a width of the perimeter wall, and an arch span that is less than a third of a height of the perimeter wall.

In varying embodiments, the beam may have nominal cross-sectional dimensions including 2×3, 2×4, 2×5, 2×6, 2×7, 2×8, 2×9, 2×10, 2×11, 2×12, 2×13, and 2×14 inches. Various different nominal cross-sectional dimensions may be contemplated such as lengths and widths between 2 to 14 inches.

Referring to FIG. 5, a structural insert 40 is disclosed. The insert 40 acts as an internal stiffener. The insert 40 is shaped to mate with the internal geometry of the beam 10. The structural insert 40 may include concave side surfaces configured to fit within the central channel. Specifically, the insert 40 may be an I-beam or solid shape configured to slide snugly into the central hourglass void 30. For example, the insert may have a profile with flanges 42 that fit within the widest portions of the hourglass-shaped channel and a web that fits within the narrowest portion. In some embodiments, the web 44 extends through the flange such that the web extends from end to end of a height of the insert. To provide reinforcement against crushing loads, the structural insert may be formed of a rigid material having a wall thickness greater than a wall thickness of the interior web structure of the extruded beam. By occupying the void 30, the insert 40 prevents the arcuate walls 20 from compressing inward. The length of the insert may extend along the entire length of the beam or may be located between beam segments in order to splice separate segments together.

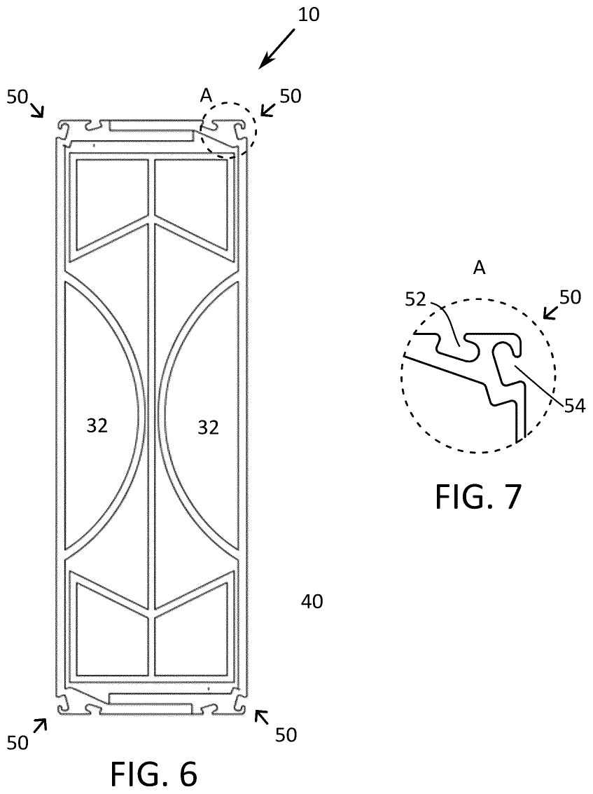

Referring to FIG. 6, the beam profiles feature an improved screening interface. Prior art beams typically required a separate 1×2 channel to hold screens. As disclosed herein, an improved structure has been created that integrates this functionality directly into the extrusion. At the corner 50 where a major wall meets a minor wall, the profile includes two distinct spline grooves (recesses adapted to receive a rubber spline and screen mesh). A first groove 52 is oriented to face a first direction (e.g., outward/horizontal). A second groove 54 is oriented to face a second direction (e.g., upward/vertical) generally orthogonal, perpendicular, or substantially obtusely oblique to the first groove. The first and second spline grooves may be distinct channels separated by a dividing wall integrally formed within the extrusion of the corner. This allows a single beam to support a “roof screen” (using the upward groove) and a “wall screen” (using the outward groove) simultaneously, or allows the builder to choose the most efficient attachment point. The grooves may be located at least two, or at all of the corners to provide reversible screening orientations.

Referring to FIG. 7, a detailed view of the corner 50 (identified as Detail A in FIG. 6) illustrates the specific geometry of the first groove 52 and the second groove 54. In the context of this disclosure, a spline groove is a continuous recess or channel designed to receive a flexible spline cord (typically rubber or vinyl) that wedges a screen mesh securely against the interior walls of the channel. As shown in this close-up, the grooves 52, 54 are not separate components attached to the beam; rather, they come from the extrusion process itself, being formed integrally within the material of the perimeter walls at the structural corner. The first groove 52 is oriented to face outwardly to receive a wall screen, while the second groove 54 is oriented to face upwardly to receive a roof screen, providing a seamless, dual-directional attachment point built directly into the beam profile.

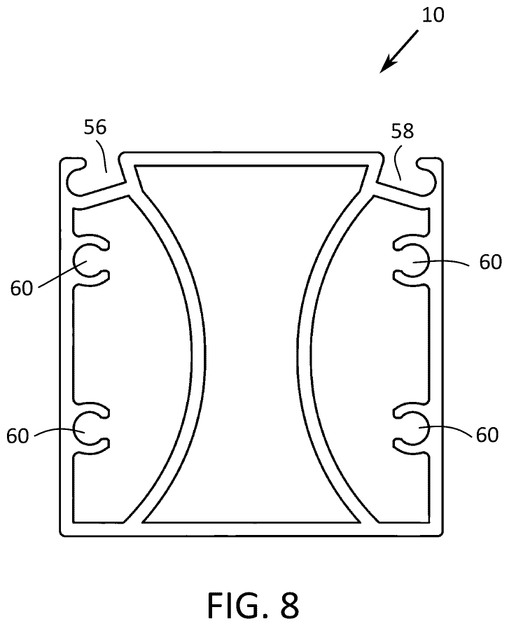

Referring now to FIG. 8, an exemplary square cross-section embodiment of the beam 10 (e.g., a nominal 2″×2″ profile) is illustrated. Despite the compact form factor, this profile retains similarities of the larger beams, featuring opposing arcuate internal walls 20 that define the central hourglass-shaped void 30. In this embodiment, the outer voids 32 located between the arcuate walls 20 and the perimeter wall further includes integral screw bosses 60 (or circular screw flutes). These bosses 60 are positioned to receive fasteners, facilitating the attachment of the beam 10 to other framing members or the anchoring of the beam to a substrate. As shown in the upper corners of the profile, spline grooves may be disposed, comprising a first groove 56 and the second groove 58, allowing this smaller structural member to accept screening on either the vertical and horizontal faces.

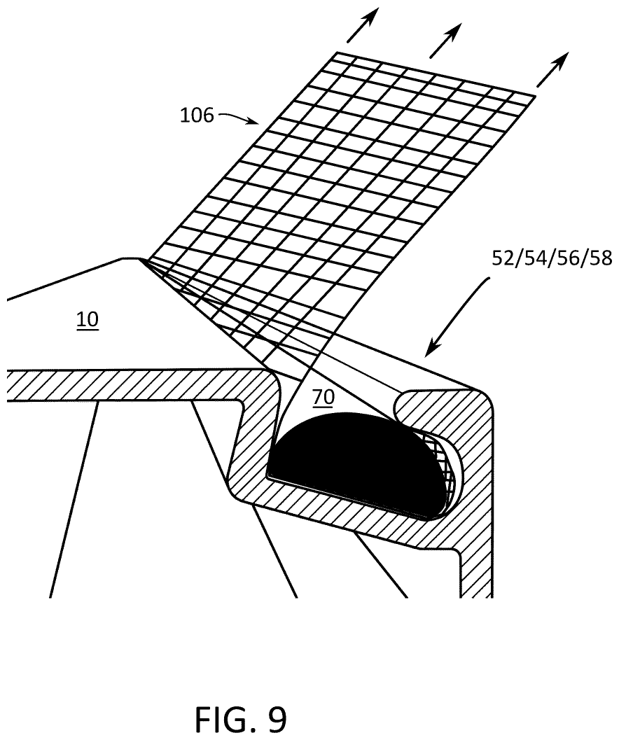

Referring to FIG. 9, a partial perspective cross-sectional view illustrates the mechanical engagement between the beam profile and the screening material. The screen mesh 106 is secured within one of the spline grooves (e.g., first groove 52 or second groove 54 or grooves 56 or 58) by a deformable spline 70 (typically a flexible rubber or vinyl cord). As depicted, the spline 70 is press-fit into the groove, capturing the screen mesh 106 between the outer surface of the spline and the inner surface of the groove. This interference fit is designed to resist pull-out forces, represented by the directional arrows, thereby maintaining the tension and structural integrity of the enclosure barrier against environmental loads such as wind.

The foregoing examples have been provided merely for the purpose of explanation and are in no way to be construed as limiting of implementations of the present invention. While aspects of the present invention have been described with reference to an exemplary embodiment, the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

What is claimed is:

1. An aluminum beam for a screened enclosure, comprising:
a perimeter wall defining a generally rectangular cross-section having two opposing major walls and two opposing minor walls;
a first spline groove located substantially at a corner of the perimeter wall, the first spline groove oriented to receive a screen spline from a first direction; and
a second spline groove located substantially at the same corner of the perimeter wall, the second spline groove oriented to receive a screen spline from a second direction different from the first direction.

2. The aluminum beam of claim 1, wherein the first direction is generally perpendicular to the major walls, and the second direction is generally perpendicular to the minor walls.

3. The aluminum beam of claim 1, wherein the first direction and the second direction are substantially obtusely oblique to each other, allowing the corner to accommodate screening on two adjacent faces of the beam simultaneously.

4. The aluminum beam of claim 1, wherein the perimeter wall comprises four corners, and wherein at least two of the corners include the first and second spline grooves to provide reversible screening orientations.

5. The aluminum beam of claim 1, wherein the first and second spline grooves are distinct channels separated by a dividing wall integrally formed within the extrusion of the corner.

6. The aluminum beam of claim 1, wherein the perimeter wall comprises four corners, and wherein at all of the corners include the first and second spline grooves to provide different screening orientations.

7. An extruded structural beam comprising:
a generally rectangular outer perimeter wall;
a first internal arcuate wall extending inwardly from a first side of the outer perimeter wall; and
a second internal arcuate wall extending inwardly from a second opposing side of the outer perimeter wall;
wherein the first and second internal arcuate walls generally oppose each other to define a central void having a substantially hourglass-shaped cross-section.

8. The extruded structural beam of claim 7, wherein the first and second internal arcuate walls comprises an arch height that is less than half a width of the perimeter wall.

9. The extruded structural beam of claim 8, wherein the first and second internal arcuate walls comprises an arch span that is less than a third of a height of the perimeter wall 10. The extruded structural beam of claim 7, wherein the first internal arcuate wall and the second internal arcuate wall converge toward a vertical centerline of the beam such that the central void is narrowest at a middle point and widest at the minor walls.

11. The extruded structural beam of claim 7, wherein the first and second internal arcuate walls are continuous curves having a constant radius.

12. The extruded structural beam of claim 7, wherein the beam is formed of two mating halves, and wherein the first internal arcuate wall is integral to the first mating half and the second internal arcuate wall is integral to the second mating half.

13. A structural beam assembly comprising:
an extruded beam having an exterior rectangular wall and an interior web structure comprising two opposing curved walls that define a central hourglass-shaped channel;
a structural insert dimensioned to be slidably received within the central hourglass-shaped channel; and
wherein the structural insert reinforces the extruded beam.

14. The structural beam assembly of claim 13, wherein the structural insert comprises a cross-sectional profile having concave side surfaces configured to fit within the central channel.

15. The structural beam assembly of claim 13, wherein the structural insert comprises a generally I-beam shaped profile having flanges that fit within the widest portions of the hourglass-shaped channel and a web that fits within the narrowest portion of the hourglass-shaped channel.

16. The structural beam assembly of claim 15, wherein the web extends through the flange such that the web extends from end to end of a height of the insert.

17. The structural beam assembly of claim 13, wherein the structural insert is an L-shaped corner coupling having a first leg inserted into the central hourglass-shaped channel of the extruded beam and a second leg adapted to receive a second beam at an angle.

18. The structural beam assembly of claim 13, wherein the structural insert is formed of a rigid material having a wall thickness greater than a wall thickness of the interior web structure of the extruded beam, thereby providing reinforcement against crushing loads.
